(19) United States
(12) Patent Application Publication
(10) Pub. No.: US 2014/0314040 A1
(43) Pub. Date: Oct. 23, 2014

(54) Control channel element allocation apparatus and method

(71) Applicant: OPTIS CELLULAR TECHNOLOGY, LLC, Plano, TX (US)

(72) Inventor: Jun Wang, Nanjing (CN)

(21) Appl. No.: 14/358,704

(22) PCT Filed: Nov. 15, 2011
(86) PCT No.: PCT/CN2011/082192

§ 371 Date: May 15, 2014

(51) Int. Cl. H04W 72/10

(52) U.S. Cl. CPC H04W 72/10; H04W 72/085
USPC 370/329

(57) ABSTRACT

According to the disclosure, there provides a control channel element (CCE) allocation method, comprising steps of: deciding an aggregation level of each of scheduled entities according to channel quality indicator (CQI) fed back from each of the scheduled entities; sorting in a list all the scheduled entities based on priority; obtaining at least two (CCE) allocation patterns each with preoccupation of (CCE) candidates by the scheduled entities by use of retrospective mechanism; selecting a (CCE) allocation pattern with maximum number of scheduled entities having preoccupied (CCE) candidates from the obtained at least two (CCE) allocation patterns; allocating (CCEs) to the scheduled entities based on the selected (CCE) allocation pattern.

### TECHNICAL FIELD

The disclosure relates to wireless communication systems, and more particularly, to a scheme for allocating control channel elements (CCE) to user equipments (UE).

### BACKGROUND

In LTE, CCE is the basic unit of PDCCH channel used to carry DCI to instruct UE to receive DL data and send UL data. It's very important for LTE transmission. Once CCE is unavailable, missed or wrongly interpreted, not only the current UE cannot receive or send data and causes waste of corresponding radio resources, but also the other UEs' transmissions will be impacted.

CCE position for specific UE are dynamically calculated in each sub-frame according to a known formula of LTE standard with parameters (such as RNTI, sub-frame, aggregation level) both at eNB and UE, so that the UE can automatically find its CCE at no more than a fixed number (usually the number is 44) of blind attempts without any prior notification from eNB. To support link adaptation, the multiple basic CCE units (1 CCE=9 REG=9*4=36 REs) can be aggregated together into four levels (CCE-1, CCE-2, CCE-4 and CCE-8) based on the encoding rates to accommodate the different UE radio conditions.

The CCE positions of different UEs calculated according to the formula usually overlap each other. To decrease the conflict among UEs, each UE has one or more CCE candidates at each of aggregation levels. The CCE allocation scheme is to have each UE to select a CCE position from its candidates without confliction with any other UE's CCE allocation.

In some cases, regardless of how to select it, there always exists the situation where some UEs (usually those with lower priority) cannot acquire their CCE allocation. But an ideal CCE allocation scheme is to fit as many as possible UEs into the PDCCH channel by carefully selecting the CCE candidate for each UE to avoid the mutual confliction.

Besides of no confliction between CCE resources of different UEs, the algorithm has some other constraints including attempt numbers, cost time, as well as consumed power etc. Then a challenging goal is raised that how to select CCE position from a group of candidates for each UE so that as many as possible UEs can get their expected CCE resources under certain constraints.

### SUMMARY

According to a first aspect of the present disclosure, there provides a control channel element (CCE) allocation method, comprising steps of: deciding an aggregation level of each of scheduled entities according to channel quality indicator (CQI) fed back from each of the scheduled entities; sorting in a list all the scheduled entities based on priority; obtaining at least two CCE allocation patterns each with preoccupation of CCE candidates by the scheduled entities by use of retrospective mechanism; selecting a CCE allocation pattern with maximum number of scheduled entities having preoccupied CCE candidates from the obtained at least two CCE allocation patterns; allocating CCEs to the scheduled entities based on the selected CCE allocation pattern.

In one embodiment, the obtaining step may comprise: for each of the scheduled entities in the sorted list, getting a current scheduled entity from the sorted list and getting idle CCE candidate list of the current scheduled entity, the idle CCE candidate list consisting of one or more idle CCE candidates which are not preoccupied by previous scheduled entities in the sorted list and are available to the current scheduled entity; in case where an idle CCE candidate for the current scheduled entity exists in the idle CCE candidate list of this current scheduled entity, preoccupying the idle CCE candidate, and moving to next scheduled entity in the sorted list; and in case where no idle CCE candidate for the current scheduled entity exists in the idle CCE candidate list of this current scheduled entity, storing a CCE allocation pattern with preoccupation of CCE candidates by respective scheduled entities, returning back to previous scheduled entity and proceeding from next idle CCE candidate in the idle CCE candidate list of the previous scheduled entity, until all of the scheduled entities have preoccupied CCE candidates or it reaches an execution time limit, ending the obtaining step.

In another embodiment, the idle CCE candidate list of the current scheduled entity may include both CCE candidates of the aggregation level decided according to the CQI fed back by the current scheduled entity and CCE candidates of aggregation levels higher than that decided according to the CQI fed back by the current scheduled entity.

In another embodiment, the deciding step may further comprise: deciding an aggregation level of each of the scheduled entities according to CQI fed back from the scheduled entity and aggregation levels higher than the aggregation level of the scheduled entity, and deciding related powers of the respective aggregation levels, and the selecting step may further comprise: selecting a CCE allocation pattern with maximum number of scheduled entities having preoccupied CCE candidates and with minimum of total power consumption of the preoccupied CCE candidates, from the obtained at least two CCE allocation patterns.

Alternatively, in another embodiment, the deciding step may further comprise: deciding an aggregation level of each of the scheduled entities according to CQI fed back from the scheduled entity and aggregation levels higher than the aggregation level of the scheduled entity, and deciding related powers of the respective aggregation levels, and the selecting step may further comprise: selecting a CCE allocation pattern having the maximum number of scheduled entities having preoccupied CCE candidates and having the most even power distribution of the preoccupied CCE candidates, from the obtained at least two CCE allocation patterns.

In another embodiment, in the idle CCE candidate list, the idle CCE candidates are sorted based on a predetermined impact rule, and the idle CCE candidates are preoccupied in order of impact from less to more.

Further in this embodiment, the predetermined impact rule is an improved lowest priority of affected scheduled entity rule in which an idle CCE candidate having lower lowest priority subsequent scheduled entity with at least one surviving candidates after subtracting an effective distance to the current scheduled entity is the one having less impact, the effective distance between a subsequent scheduled entity to the current scheduled entity is a number of scheduled entities subsequent to the subsequent scheduled entity having idle CCE candidates conflicting with the subsequent entity.

In another embodiment, the CCE allocation method may further comprise: caching the selected CCE allocation pattern for a predetermined period of time.

Further in this embodiment, the CCE allocation method may further comprise, after the sorting step, matching the cached CCE allocation pattern with a sorted list of scheduled entities; in case where the cached CCE allocation pattern is matched, allocating CCEs to the scheduled entities based on the matched cached CCE allocation pattern, and ending the CCE allocation method; and in case where no cached CCE allocation pattern is matched, going to the subsequent steps.

According to a second aspect of the present disclosure, there provides a control channel element (CCE) allocation apparatus, comprising: a deciding unit configured to decide an aggregation level of each of scheduled entities according to channel quality indicator (CQI) fed back from each of the scheduled entities; an entity sorting unit configured to sort in a list all the scheduled entities based on priority; an allocation pattern obtaining unit configured to obtain at least two CCE allocation patterns each with preoccupation of CCE candidates by the scheduled entities, by use of retrospective mechanism; an allocation pattern selecting unit configured to select a CCE allocation pattern with maximum number of scheduled entities having preoccupied CCE candidates, from the obtained at least two CCE allocation patterns; an allocating unit configured to allocate CCEs to the scheduled entities based on the selected CCE allocation pattern.

In one embodiment, the allocation pattern obtaining unit is further configured to: for each of the scheduled entities in the sorted list, get a current scheduled entity from the sorted list and getting idle CCE candidate list of the current scheduled entity, the idle CCE candidate list consisting of one or more idle CCE candidates which are not preoccupied by previous scheduled entities in the sorted list and are available to the current scheduled entity; in case where an idle CCE candidate for the current scheduled entity exists in the idle CCE candidate list of this current scheduled entity, preoccupy the idle CCE candidate, and move to next scheduled entity in the sorted list; and in case where no idle CCE candidate for the current scheduled entity exists in the idle CCE candidate list of this current scheduled entity, store a CCE allocation pattern with preoccupation of CCE candidates by respective scheduled entities, return back to previous scheduled entity and proceed from next idle CCE candidate in the idle CCE candidate list of the previous scheduled entity, until all of the scheduled entities have preoccupied CCE candidates or it reaches an execution time limit, end the operation of the allocation pattern obtaining unit.

In another embodiment, the idle CCE candidate list of the current scheduled entity includes both CCE candidates of the aggregation level decided according to the CQI fed back by the current scheduled entity and CCE candidates of aggregation levels higher than that decided according to the CQI fed back by the current scheduled entity.

In another embodiment, the allocation pattern obtaining unit is further configured to sort the idle CCE candidates in the idle CCE candidate list, based on a predetermined impact rule, and to preoccupy the idle CCE candidates in order of impact from less to more.

In another embodiment, the CCE allocation apparatus may further comprise: an allocation pattern caching unit configured to cache the selected CCE allocation pattern for a predetermined period of time.

Further in this embodiment, the allocation pattern caching unit is further configured to match the cached CCE allocation pattern with a sorted list of scheduled entities, and the allocating unit is further configured to, in case where the cached CCE allocation pattern is matched, allocate CCEs to the scheduled entities based on the matched cached CCE allocation pattern.

### BRIEF DESCRIPTION OF THE DRAWINGS

The above and other objects, features and advantages of the present invention will be clearer from the following detailed description about the non-limited embodiments of the present invention taken in conjunction with the accompanied drawings, in which:

FIG. 1 is flowchart illustrating the existing CCE allocation implementation;

FIG. 2 is a flowchart illustrating the CCE allocation method according to the first embodiment of the present invention;

FIG. 3 is a block diagram illustrating the CCE allocation apparatus according to the first embodiment of the present invention;

FIG. 4 is a flowchart illustrating the CCE allocation method according to the second embodiment of the present invention;

FIG. 5 is a portion of flow chart illustrating the CCE allocation method according to the third embodiment of the present invention;

FIG. 6A shows four data structures and corresponding relationship among those data structures to be used in the binary tree;

FIG. 6B shows the relationship between the CCE bitmap and the CCE candidates in different aggregation levels

FIG. 7 shows the flowchart of the Compare Candidates Routine;

FIG. 8 shows the flowchart of the Evaluate Impact Routine;

FIG. 9 is a portion of flow chart illustrating the CCE allocation method according to the fourth embodiment of the present invention;

FIG. 10 shows two kinds of data structures, B+ tree and Allocation Pattern, and their relationship together;

FIG. 11 shows the flowchart of the Search Cache Routine;

FIG. 12 shows a schematic diagram of search B+ tree scenarios, where it provides 6 different input RNTI lists each marked as different line shapes to distinguish each other;

FIG. 13 shows the flowchart of the Insert Cache Routine;

FIG. 14 shows the flowchart of the Delete Cache Routine;

FIG. 15 is a block diagram illustrating the CCE allocation apparatus according to the fourth embodiment of the present invention; and

FIG. 16 is a schematic diagram showing the simulating scenario where 8 UEs in DL and 8 UEs in UL are to be scheduled at each TTI.

Throughout the drawings, the same or similar elements or steps are identified by the same or similar reference signs.

### DETAILED DESCRIPTION OF EMBODIMENTS

Hereunder, the embodiments of the present invention will be described in accordance with the drawings. In the following description, some particular embodiments are used for the purpose of description only, which shall not be understood as any limitation to the present invention but the examples thereof. While it may blur the understanding of the present invention, the conventional structure or construction will be omitted.

Because CCE allocation need be finished within each sub-frame (usually 1 ms), the execution time of the CCE allocation scheme need be constrained within shorter interval. Currently existing CCE allocation implementation is very straightforward, which adopts linear probing method, as described below

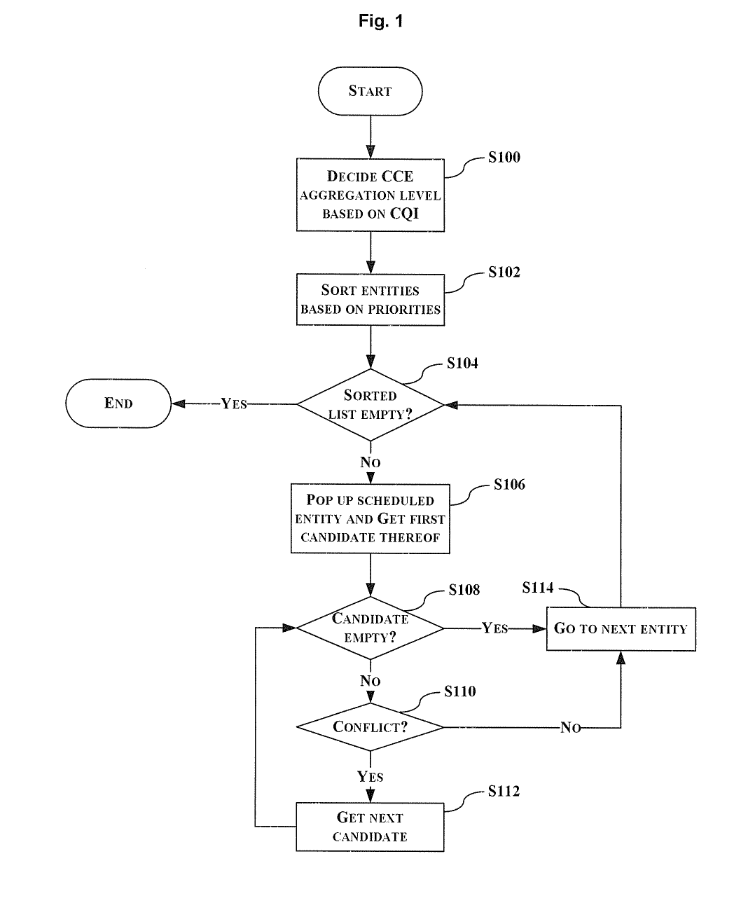

FIG. 1 is flowchart illustrating the existing CCE allocation implementation. Referring to FIG. 1, this implementation includes the following steps.
Step S100, an aggregation level of each scheduled entity is decided according to its CQI feedback.
Step S102, all scheduled entities are sorted in order of priority from high to low,
Steps S104-S114, a scheduled entity is got from the sorted list (S106) and its each CCE candidate within the decided aggregation level is tried until an idle CCE position is found (S108-S112, S110: No) and then the procedure goes further to next entity of sorted list (S114); if all candidates of the scheduled entity conflict with others (S108: Yes), then the entity is skipped and the next entity of sorted list is tried (S114).

However, the above existing implementation has the following problems:
1. Not best solution is chosen, For a given scheduled entity (UE), the existing implementation browses its CCE candidates; once finding an idle one, it immediately occupies the position and tries next scheduled entity. Actually the 1^{st} found idle position may NOT be the best one, since it may conflict with more subsequent scheduled entities simultaneously, and thus block them from acquiring CCE resources. On the contrary, selecting other idle candidate may result in less confliction.
There is no any known formula to calculate the best CCE position easily. Moreover, the best CCE position is not only related with current entity, but also need take its subsequent entities into consideration. The inventor found a feasible method is to do pseudo-occupation and measurement on CCE candidates and find the best one from all candidates which can hold most scheduled entities. To implement such a goal, it's better to introduce retrospective mechanism,
2. Random order of checking CCE candidate. Now, the order of candidate attempt within a specific scheduled entity is random until an idle one is found. But actually, the candidate sequence has its relative importance. For example, for one candidate, once it's occupied, it will block many subsequent entities' CCE candidates; but for another candidate, it may have few even no confliction& Occupation of a candidate with the minimum confliction may achieve better effect. So, appropriate arrangement of candidate order can help to find a better CCE allocation plan more quickly.

3. Only one CCE aggregation level is tried. Only the aggregation level decided based on the CQI feedback is tried and other higher aggregation levels are ignored, since this is based on an assumption that if no CCE of lower aggregation level can be found, those at higher level must be unavailable also.

Actually, the above assumption may be NOT correct, Since the CCE positions of different aggregation levels have nothing to do with each other at all. When one level CCE pool is exhausted, the other levels may be not. So it is better to allow for those higher aggregation levels of CCE to be attempted if the decided level fails (those lower aggregation levels do not have to be checked due to radio environment).

4. Those factors other than CCE confliction are ignored. The existing implementation only considers the confliction between CCE resources, not caring about other constraints, such as power consumption on the CCE, which may result in another issue that even if the allocated CCE does not conflict with all the others, the total power at the corresponding timeslot may exceed the maximum transmission power if too many allocated CCEs are located at one timeslot. By the way, even if the total power does not exceed the limit, the uneven power distribution among PDCCH symbols will also cause the performance degradation of RF transmitter. So, it is better to take the power consumption into consideration.

Therefore, this invention is made at least aiming to solve the following technical problems:
Acquisition of a CCE within PDCCH is the precondition of scheduling UE. Unfortunately, not each idle CCE can be freely allocated for a given UE which can be only selected from several candidates. When those predefined CCE candidates are all occupied by other UEs, the UE cannot be scheduled even there are still other idle CCEs left in PDCCH.
So, how to fit as many as possible UEs into PDCCH becomes a critical goal which directly decides the number of UEs simultaneously scheduled in one TTI. Because the CCE candidates of different UEs may overlap with each other, the candidates must be selected very carefully; otherwise one UE's inappropriate CCE selection may block subsequent UEs, which will make CCE resource become the bottleneck of overall LTE performance.

Apparently there is no known formula to exactly calculate the CCE position for each UE to achieve the goal of fitting the most UEs in PDCCH. Attempt of different candidates among multiple UEs can get the best selection pattern, i.e., one CCE allocation pattern best in term of number of UEs having allocated CCEs, or best in term of total power consumption, or best in term of evenness of power distribution, or any suitable combination of these terms.

### First Embodiment

As the first embodiment of the invention, there provides a CCE allocation scheme in which a retrospective mechanism is adopted.

According to this embodiment, each allocation pattern is composed of a group of UE's CCE positions. To choose the best one from a set of CCE allocation patterns, the retrospective mechanism is introduced, which tries an idle candidate temporarily for a given UE and steps to further level to explore next UEs' CCE selection until all UEs have got their CCEs or no idle CCE is left, then it returns back to upper UE level to try its next idle candidate and then goes down again.

Unlike the straightforward CCE search scheme, which just finds the 1^{st} available CCE pattern, the retrospective mechanism can enumerate all possible CCE selection patterns from which the best one with the most UEs can be found.

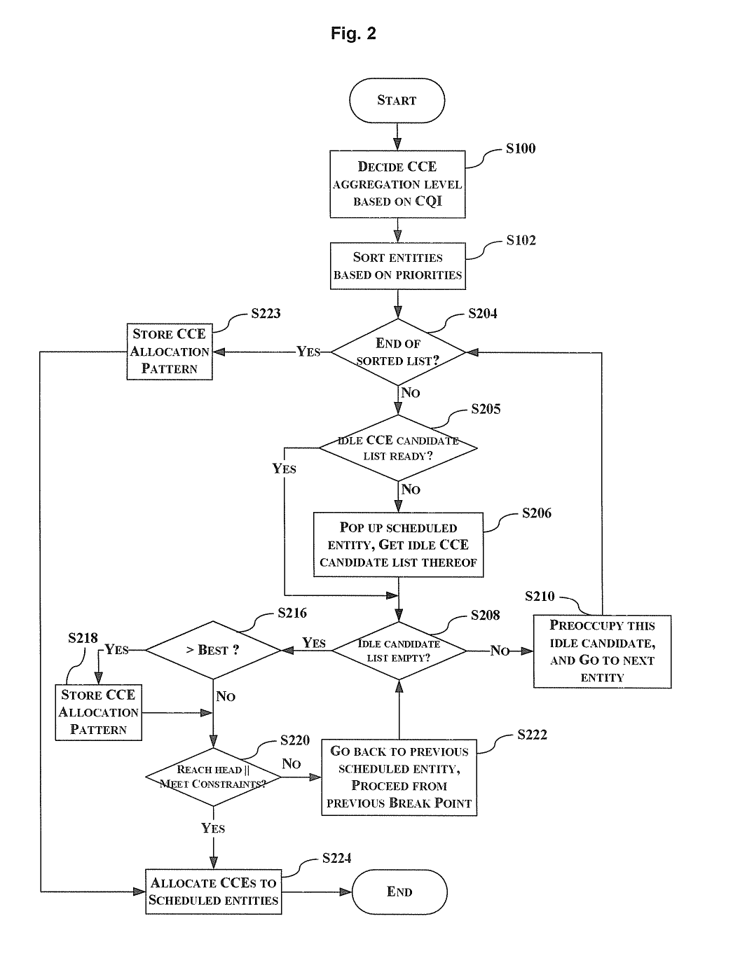

FIG. 2 is a flowchart illustrating the CCE allocation method according to the first embodiment of the present invention.

Referring to FIG. 2, the CCE allocation method adopts iterative procedure, each iteration stands for an exploration attempt, which means the exploration attempt at most equals to the number of scheduled entities. The CCE allocation method may include one or more of the following steps:
Step S100, an aggregation level of each scheduled entity is decided according to its CQI feedback.
Step S102, all scheduled entities are sorted in a list, for example, according to the order of priority from high to low.
Step S204, it decides whether it reaches the end of the list of all scheduled entities; if not, the procedure goes to step S205 if yes, it means that one CCE allocation pattern is obtained, this CCE allocation pattern indicates the preoccupation of CCE candidates by the scheduled entities (here all scheduled entities have their respective preoccupied CCE candidates), and the procedure goes to step S224 after this CCE allocation pattern is stored as the best CCE allocation pattern (S223).
Step S206, an entity is got from the sorted list and idle CCE candidate list of this entity is get. The idle CCE candidate list consists of idle CCE candidates which are not preoccupied by previous scheduled entities and are available to the current scheduled entity.
Steps S208 and S210, if an idle CCE candidate for the current scheduled entity exists in the idle CCE candidate list of this current scheduled entity (S208: NO), this idle CCE candidate is preoccupied (i.e., occupied temporarily and to be allocated later), and the procedure moves further down to next scheduled entity (S210), then goes to step S204.
Steps S216 and S218, if no idle CCE candidate for the current scheduled entity exists in the idle CCE candidate list of this current scheduled entity (S208: YES), it means that one CCE allocation pattern is obtained, this CCE allocation pattern indicates the preoccupation of CCE candidates by the scheduled entities (here all scheduled entities before the current scheduled entity in the sorted list have their respective preoccupied CCE candidates); in step S216, this CCE allocation pattern is compared with the stored best CCE allocation pattern in term of the number of scheduled entities; if the number of scheduled entities having preoccupied CCE candidates of this CCE allocation pattern is larger than that of the stored best CCE allocation pattern (S216: YES), then this CCE allocation pattern is stored as the stored best CCE allocation pattern to replace the previously stored best CCE allocation pattern (S218), and then the procedure goes to step S220; otherwise, if the number of scheduled entities having preoccupied CCE candidates of this CCE allocation pattern is not larger than that of the stored best CCE allocation pattern (S216: NO), the previously stored best CCE allocation pattern is remained unchanged, and the procedure goes to step S220 directly.
Steps S220 and S222, it decides whether the current scheduled entity is the head of the list of all scheduled entities or some constraints (such as execution time) are met (S220), if so (S220: YES), the procedure goes to step S224; otherwise (S220: NO), the procedure returns back to previous scheduled entity and proceeds from next CCE candidate in the CCE candidate list of the previous scheduled entity (S222, S208), then the procedure goes through steps S210 and S204 to move down into the current scheduled entity and repeats the previous actions again.
   Herein, an iterative retrospective mechanism is introduced by steps sequence S208→S216→S220→S222→S208.
Step S224, the CCEs are allocated to the scheduled entities according to the stored best CCE allocation pattern, and the CCE allocation method according to this embodiment of the present invention is ended.

As above, the retrospective mechanism is introduced into the CCE allocation procedure, therefore the CCE allocation pattern best in term of the number of the scheduled entities can be found.

It is noted that, in step S206, the idle CCE candidate list of the current entity may include only those idle CCE candidates of the aggregation level decided based on the CQI feedback of the current entity. Preferably, the idle CCE candidate list of the current entity may include not only those idle CCE candidates of the aggregation level decided based on the CQI feedback of the current entity, but also those idle CCE candidates of the aggregation levels higher than that decided based on the CQI feedback of the current entity. In case where the idle CCE candidate list includes the idle CCE candidates of both the decided aggregation level and higher levels, it will allow that those higher aggregation levels of CCE can be attempted if the decided level fails,

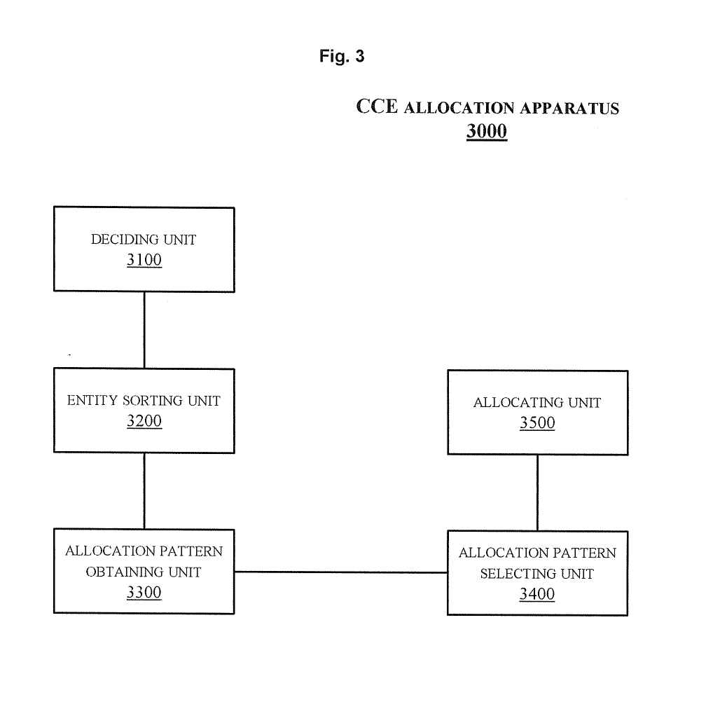

FIG. 3 is a block diagram illustrating the CCE allocation apparatus according to the first embodiment of the present invention.

As shown in FIG. 3, the CCE allocation apparatus 3000 according to the first embodiment of the present invention includes one or more of a deciding unit 3100, an entity sorting unit 3200, an allocation pattern obtaining unit 3300, an allocation pattern selecting unit 3400, and an allocating unit 3500.

The deciding unit 3100 is configured to decide an aggregation level of each of scheduled entities according to CQI fed back from each of the scheduled entities (Step S100 in FIG. 2).

The entity sorting unit 3200 is configured to sort in a list all the scheduled entities based on priority, for example, according to the order of priority from high to low (Step S102 in FIG. 2).

The allocation pattern obtaining unit 3300 is configured to obtain possible CCE allocation patterns each with preoccupation of CCE candidates by the scheduled entities, by use of retrospective mechanism (Steps S208→S216→S220→S222 →S208 in FIG. 2).

For example, the allocation pattern obtaining unit 3300 is configured to, for each of the scheduled entities in the sorted list, get a current scheduled entity from the sorted list and getting idle CCE candidate list of the current scheduled entity, the idle CCE candidate list consisting of one or more idle CCE candidates which are not preoccupied by previous scheduled entities in the sorted list and are available to the current scheduled entity (Step S206 in FIG. 2); in case where an idle CCE candidate for the current scheduled entity exists in the idle CCE candidate list of this current scheduled entity, preoccupy the idle CCE candidate, and move to next scheduled entity in the sorted list (Step S210 in FIG. 2); and in case where no idle CCE candidate for the current scheduled entity exists in the idle CCE candidate list of this current scheduled entity, store a CCE allocation pattern with preoccupation of CCE candidates by respective scheduled entities, return back to previous scheduled entity and proceed from next idle CCE candidate in the idle CCE candidate list of the previous scheduled entity (Steps S222, S208 in FIG. 2), until all of the scheduled entities have preoccupied CCE candidates or it reaches an execution time limit (Step S220 in FIG. 2), end the operation of the allocation pattern obtaining unit 3300.

Similarly as in step S206 of FIG. 2, the idle CCE candidate list of the current entity may include only those idle CCE candidates of the aggregation level decided based on the CQI feedback of the current entity. Preferably, the idle CCE candidate list of the current entity may include not only those idle CCE candidates of the aggregation level decided based on the CQI feedback of the current entity, but also those idle CCE candidates of the aggregation levels higher than that decided based on the CQI feedback of the current entity. In case where the idle CCE candidate list includes the idle CCE candidates of both the decided aggregation level and higher levels, it will allow that those higher aggregation levels of CCE can be attempted if the decided level fails.

The allocation pattern selecting unit 3400 is configured to select a CCE allocation pattern with maximum number of scheduled entities having preoccupied CCE candidates, from the obtained at least two CCE allocation patterns (steps S216 and S218 in FIG. 2).

The allocating unit 3500 is configured to allocate CCEs to the scheduled entities based on the selected CCE allocation pattern (step S224 in FIG. 2).

According to the first embodiment of the present invention, at least two CCE allocation pattern with preoccupation of CCE candidates by the scheduled entities (usually UEs) can be obtained by retrospective mechanism, and among these two obtained CCE allocation pattern, the one having the maximum number of scheduled entities having preoccupied CCE candidates is selected, Therefore, the present technique provides more flexibility in the CCE candidates than the straightforward existing scheme.

### Second Embodiment

As the second embodiment of the invention, the constraint of power consumption on the CCEs is further considered. Compared with the first embodiment of the invention, only some minor changes are needed. Therefore, the similar steps and components to those in the first embodiment are indicated with the same reference numbers and the detailed descriptions thereof are omitted for clarity.

As described above, now a scheduled entity is allowed to select not only the CCE candidates of the aggregation level decided based on its CQI feedback but also those of aggregation levels higher than the decided one. Because higher aggregation level means higher power consumption, the constraint of power consumption on the CCEs will be considered.

Since CCE will be finally distributed among the whole PDCCH symbol range, the power consumption on the specific CCE will also be spread on the different symbols. If the power is NOT checked during the candidate selection, most allocated CCEs may be aggregated on a specific symbol, with the exceeding of the maximum limit of transmission power.

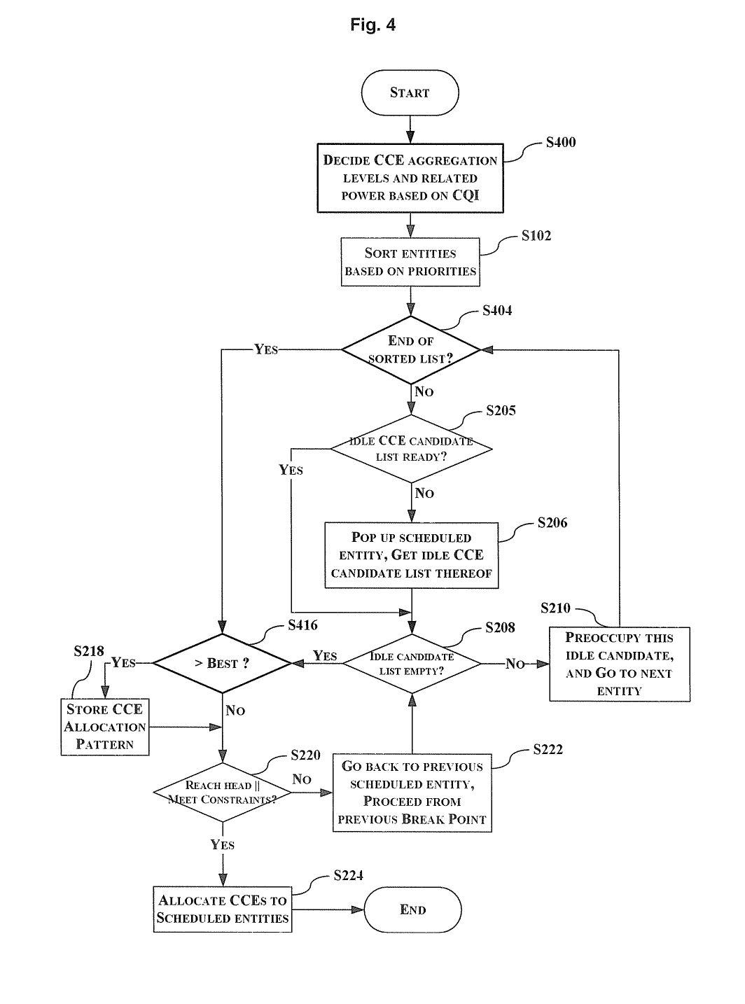

FIG. 4 is a flowchart illustrating the CCE allocation method according to the second embodiment of the present invention.

Referring to FIG. 4, the CCE allocation method may include one or more of the following steps:
Step S400, an aggregation level of each scheduled entity is decided according to its CQI feedback, aggregation levels higher than the aggregation level decided based on its CQI feedback are also decided and related powers of respective aggregation levels are determined.
Step S102, same as that in the first embodiment.
Step S404, it decides whether it reaches the end of the list of all scheduled entities; if not, the procedure goes to step S205; if yes, it means that one CCE allocation pattern is obtained, this CCE allocation pattern indicates the preoccupation of CCE candidates by the scheduled entities (here all scheduled entities have their respective preoccupied CCE candidates) and also power consumptions and/or power distribution of these preoccupied CCE candidates, and the procedure goes to step S416 for comparison.
Step S206, S208 and S210, same as those in the first embodiment.
Steps S416 and S218, if no idle CCE candidate for the current scheduled entity exists in the idle CCE candidate list of this current scheduled entity (S208: YES), it means that one CCE allocation pattern is obtained, this CCE allocation pattern indicates the preoccupation of CCE candidates by the scheduled entities (here all scheduled entities before the current scheduled entity in the sorted list have their respective preoccupied CCE candidates) and also power consumptions and/or power distribution of these preoccupied CCE candidates is obtained; in step S416, this CCE allocation pattern is compared with the stored best CCE allocation pattern in terms of the number of scheduled entities, the total power consumption and/or power distribution; if the number of scheduled entities having preoccupied CCE candidates of this CCE allocation pattern is larger than that of the stored best CCE allocation pattern (S416: YES), then this CCE allocation pattern is stored as the stored best CCE allocation pattern to replace the previously stored best CCE allocation pattern (S218), and then the procedure goes to step S220; if the number of scheduled entities having preoccupied CCE candidates of this CCE allocation pattern is smaller than that of the stored best CCE allocation pattern (S416: NO), the previously stored best CCE allocation pattern is remained unchanged, and the procedure goes to step S220 directly; if the number of scheduled entities having preoccupied CCE candidates of this CCE allocation pattern is equal to that of the stored best CCE allocation pattern, then the total power consumptions and/or the power distributions of these two CCE allocation patterns are evaluated; for example, if the total power consumption of this CCE allocation pattern is smaller than that of the stored best CCE allocation pattern (S416: YES), then this CCE allocation pattern is stored as the stored best CCE allocation pattern to replace the previously stored best CCE allocation pattern (S218), and then the procedure goes to step S220; if the total power consumption of this CCE allocation pattern is not smaller than that of the stored best CCE allocation pattern (S416: NO), the previously stored best CCE allocation pattern is remained unchanged, and the procedure goes to step S220 directly; or as another example, if the power distribution of this CCE allocation pattern is evener than that of the stored best CCE allocation pattern (S416: YES), then this CCE allocation pattern is stored as the stored best CCE allocation pattern to replace the previously stored best CCE allocation pattern (S218), and then the procedure goes to step S220; if the power distribution of this CCE allocation pattern is not evener than that of the stored best CCE allocation pattern (S416: NO), the previously stored best CCE allocation pattern is remained unchanged, and the procedure goes to step S220 directly.
Steps S220, S222 and S224, same as those in the first embodiment.

With evaluation of pattern at the end of each round of iteration, the power consumption may be considered:
[1] With the minimum total power consumption at the same allocated number of scheduled entities, so that no total power of any PDCCH symbol will exceed the maximum transmission power; and/or
[2] With the most evenness (minimum mean square deviation) of power distribution at the same allocated number of scheduled entities and/or the same total power consumption.

The CCE allocation apparatus according to the second embodiment of the present invention includes the similar units as those in the first embodiment of the present invention but introduces some minor changes therein. For example, the deciding unit 3100 is further configured to decide an aggregation level of each of the scheduled entities according to CQI fed back from the scheduled entity and aggregation levels higher than the aggregation level of the scheduled entity, and deciding related powers of the respective aggregation levels (Step S400 in FIG. 4). The allocation pattern selecting unit 3400 is further configured to select a CCE allocation pattern with minimum of total power consumption of the preoccupied CCE candidates and/or with the most even power distribution of the preoccupied CCE candidates, from the CCE allocation patterns with the same maximum number of scheduled entities having preoccupied CCE candidates (Step S416 in FIG. 4). The other units are identical to those in the first embodiment and therefore the detailed descriptions thereof are omitted for simplicity and clarity.

According to the second embodiment of the present invention, not only the numbers of scheduled entities having preoccupied CCE candidates but also the power consumptions/distributions of respective CCE allocation patterns are considered.

### Third Embodiment

Although theoretically speaking, the retrospective mechanism in the first and second embodiments must be able to get best result, it's usually time-consuming. Because in some cases, the set of all possible CCE selection patterns is very large, it is very difficult to enumerate the whole set within a limited time interval (<1 ms).

As mentioned above, to find the best pattern, the retrospective mechanism need explore every available candidate for each entity. Considering there are N entities and each of them has M CCE candidates, then the maximum attempt number will be at most M^{N}, and thus it is very difficult to finish all attempts within the execution time constraint.

After carefully analyzing the overlap relationship of CCE candidates among scheduled entities, it's found that those CCE candidates have different impact effect on subsequent entities. It is better that the candidates with littler impact are explored in advance to those with more impact so that the best pattern can be found as soon as possible.

Therefore, the exploration order of candidates in the idle CCE candidate list of a given UE level need be chosen carefully based on a certain criteria, preferably based on minimum impact on the subsequent UEs. For example, if a candidate does not overlap with any other UEs, it can be chosen with higher preference, since allocation of such a CCE adds one more UE into PDCCH without imposing negative impact on other UEs.

Considering above, a prediction mechanism may be introduced into the embodiments of the present invention.

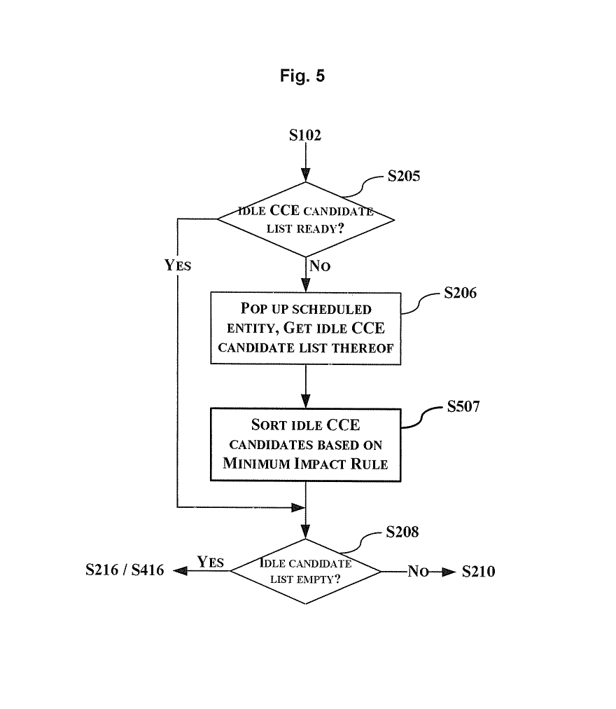

FIG. 5 is a portion of flow chart illustrating the CCE allocation method according to the third embodiment of the present invention.

The third embodiment can be incorporated into the first or second embodiment by inserting a step S507 between the steps S206 and S208. The other steps are identical or similar to those of the first or second embodiment, and therefore the detailed descriptions thereof are omitted for simplicity.

In the newly added step S507, the idle CCE candidates are sorted based on a predetermined impact rule,

As examples, in the third embodiments of the present invention, there are introduced four impact rules for sorting the idle CCE candidates,
MINIMUM AFFECTED SCHEDULED ENTITY RULE
   The k^{th} candidate CCEₖ is chosen for UEᵢ according to the following criteria:

$$I ( {{CCE}_{k}}_{min} ) \vert {CCE}_{k} ∈ {\{ Candidate \}}_{{UE}_{i}} , where$$

$$I ( {CCE}_{k} ) = {\sum }_{j = i + 1} {UE}_{j} \vert {UE}_{j} ' s candidate overlaps {CCE}_{k}$$

The CCE candidate which impacts minimum number of subsequent entities is selected. For example, if a CCE candidate does not conflict with any subsequent scheduled entities, it should be a best selection.
MAXIMUM SURVIVED CCE CANDIDATE RULE
   The k^{th} candidate CCEₖ is chosen for UEᵢ according to the following criteria:

$$S ( {{CCE}_{k}}_{max} ) \vert {CCE}_{k} ∈ {\{ Candidate \}}_{{UE}_{i}} , where$$

$$S ( {CCE}_{k} ) = min ( {Num}_{idle\_CCE j = i + 1} ( {UE}_{j} ) ) \vert {UE}_{j} ' s candidate overlaps {CCE}_{k}$$

The 1^{st} minimum affected scheduled entity rule has a defect, For example, a scheduled entity has two idle CCE candidates, one of which conflicts with other two subsequent entities both having more survived CCE candidates left even if the conflicted candidate is excluded. On the other hand, the other idle CCE candidate only impacts one subsequent entity however just having one idle CCE candidate. Once the sole idle CCE candidate is occupied by previous scheduled entity, the subsequent entity will NOT get its CCE.
So compared with Minimum affected entity number, the survived CCE candidate number of those affected entities (Num_{idle}_{_{—}}_{CCE}(*)) indicates the impact effect more exactly.
LOWEST PRIORITY OF AFFECTED SCHEDULED ENTITY RULE
   The k^{th} candidate is chosen for UEᵢ according to the following criteria:

$$D ( {{CCE}_{k}}_{min} ) \vert {CCE}_{k} ∈ {\{ Candidate \}}_{{UE}_{i}} , where$$

$$D ( {CCE}_{k} ) = {Priority}_{min} ( [ {Num}_{idle\_CCE j = i + 1} ( {UE}_{j} ) - ( j - i ) ] > 0 ) \vert {UE}_{j} ' s candidate overlaps {CCE}_{k}$$

With further consideration, it can be found that the maximum survived CCE candidate rule still has an issue. For example, the i^{th} entity has two candidates, the 1^{st} candidate of which impacts (i+1)^{th} entity which only has one idle candidate, and the 2^{nd} candidate of which impacts (i+3)^{th} entity which only has two idle candidates. According to above maximum survived CCE candidate rule, the 2^{nd} candidate will be chosen with higher preference. However, due to the scheduled entity is allocated CCE resources in order of priority, when the procedure goes from i^{th} to (i+3)th entity, the (i+1)^{th} and (i+2)^{th} entities have already got their CCE resources, whose candidates may also block the two candidates of (i+3)^{th} entity. In such a case, the 1^{st} candidate, on the contrary, may be the better alternative.
So not only the survived CCE candidate number, but also the distance between current entity and affected entity (j-i) should also be considered. Once the survived CCE candidate number cannot afford the distance, the affected entity may become the first one that can't get CCE and the prediction should stop and the candidate of whose first scheduled entity failing to get CCE has lowest priority

$$( the furthest distance ) ( {Priority}_{min} (* ) )$$

should be chosen.
IMPROVED LOWEST PRIORITY OF AFFECTED SCHEDULED ENTITY RULE
   The k^{th} candidate is chosen for UEᵢ according to the following criteria:

$$DI ( {{CCE}_{k}}_{min} ) \vert {CCE}_{k} ∈ {\{ Candidate \}}_{{UE}_{i}} , where$$

$$DI ( {CCE}_{k} ) = {Priority}_{min} ( [ {Num}_{idle\_CCE j = i + 1} ( {UE}_{j} ) - {\sum }_{{UE}_{j}} ] > 0 ) \vert {UE}_{j} ' s candidate overlaps {CCE}_{k}$$

$${\sum }_{{UE}_{j}} = {\sum }_{n = i + 1}^{j} {UE}_{n} \vert {UE}_{n} ' s candidate overlaps {UE}_{j} ' s$$

Actually above lowest priority of affected scheduled entity rule potentially imposes an assumption that every entity along the path between i^{th} and (i+3)th entity always has overlapped candidates with (i+3)^{th} entity, so survived candidate number need be checked after subtracting the distance. However, in most cases, the assumption is too strict, almost impossible to have every entity along the path always overlaps candidate with (i+3)^{th} entity.
To increase the accuracy, the rule can be improved as that every entity along path need be checked against (i+3)^{th} entity whether they have overlapped candidates. If so, the distance is valid (i.e., effective distance) and the procedure goes to next entity, otherwise the distance is invalid and should NOT be subtracted by the survived candidate number.
Besides of distance concept, another parameter “exploration step” (e.g., 3 as default, which means j is from i+1 to i+3) is introduced into evaluation. The So-called exploration step indicates the longest distance between current entity and affected entity, i.e., j is from i+1 to i+(exploration step). For those entities out of the exploration step, they will NOT be considered any more, since impact evaluation over such a long distance may be not correct at all, while the incorrect evaluation in prediction procedure will degrade the accuracy instead.

Therefore, in the CCE candidate sorting step S507, impact effect of a given CCE candidate need to be evaluated, In this regard, affected entities need be to acquired at first. However, the acquisition of affected entities is NOT so easy as checking CCE overlap, since there are many other entities, each of them has many CCE candidates. So long as any one candidate overlaps with given CCE candidate, the entity will be marked as affected. Searching among all entities one by one and checking overlap is of course a time consuming task, and should be avoided as little as possible.

Binary Tree

Thus it adopts binary tree structure as an example for implementing any one of the previously described four impact rules.

Since a CCE-n can be divided into two CCE-(n−1), it is reasonable to link the CCE-i into a binary tree. The tree at most has 4 layers, from CCE-8 as root to CCE-1 as leaf, within which each tree node has an external list that links all the

CCE candidates at corresponding aggregation level and CCE position in order of priority from high to low, When it need acquire the affected entity group, it does not have to search for all other entities. Instead, it only need do in following three steps of:
1. Searching for the external list which includes all other candidates at same aggregation level.
2. Searching for the parent node' external list which includes all the candidates at higher aggregation level,
3. Searching for all children node's external list, which includes all the candidates at lower aggregation level,

Therefore, the binary tree actually partitions the whole entity group into multiple sub-groups, each of which is covered by a CCE-8. Through the binary tree structure, it only need search a subset of entities group instead of the whole group. Because the acquisition of affected entities is frequently used in the step S507, improvement of performance at once execution can greatly improve the overall performance,

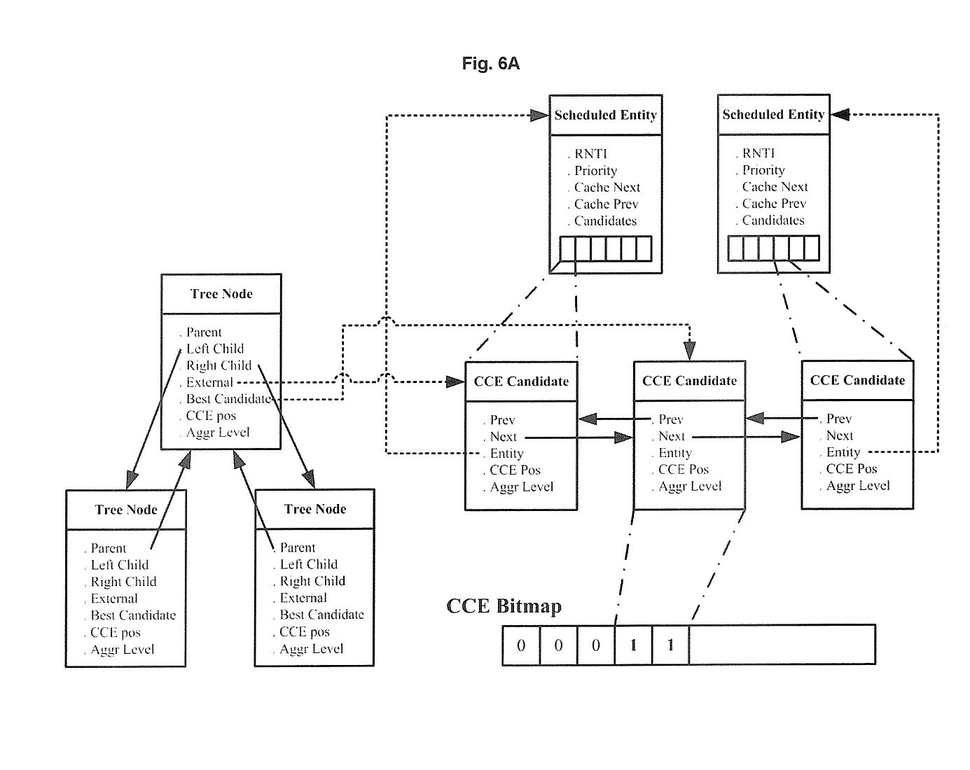

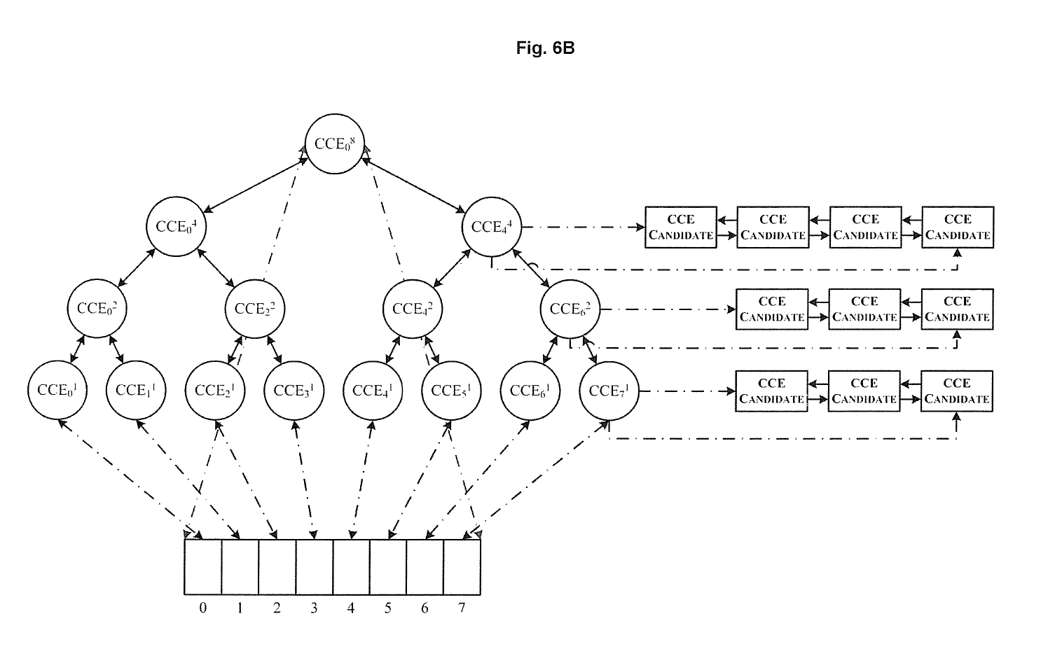

FIG. 6A shows four data structures and corresponding relationship among those data structures to be used in the binary tree.

1. Tree node:
Internal node of binary tree used to search for the affected entities.
   Parent: pointing to parent node
   Left child: pointing to left child node
   Right child: pointing to right child node
   External: pointing to external candidate list
   Best candidate: pointing to current chosen best CCE candidate
   CCE position: CCE start position referred by current node
   Aggr level: aggregation level (CCE-1 to CCE-8) referred by current node
2. CCE candidate:
CCE candidate calculated from known formula.
   Prev: pointing to its predecessor within external list
   Next: pointing to its successor within external list
   Entity: pointing to its owning scheduled entity
   CCE position: CCE start position referred by current node
   Aggr level: aggregation level (CCE-1 to CCE-8) referred by current node

3. Scheduled entity:
Basic scheduled unit, usually referring to a UE
   RNTI: Radio network temporary indicator
   Priority: priority of scheduled entity
   Candidates: an array of CCE candidates calculated by known formula
   Cache next: pointing to the first B+ tree node belonging to current scheduled entity
   Cache prey: pointing to the last B+ tree node belongs to current scheduled entity

CCE bitmap:
a bitmap each of bit indicating occupation state of a CCE

FIG. 6B shows the relationship between the CCE bitmap and the CCE candidates in different aggregation levels.

As shown in FIG. 6B, the circle of CCEⁱⱼ stands for the binary tree internal node which has two points pointing to the head and tail of external list of CCE candidates indicated by rectangles. Those CCE candidates linked into same list may come from different entities, but all refer to the same CCE position in PDCCH. The below array refers to the bitmap, each of bit represents a single CCE¹ unit (36 Res), so one byte (8 bits) is corresponding to a CCE⁸. Once the CCE unit is occupied, the corresponding bits are set to ONE, otherwise cleared to ZERO.

Compare Candidates Routine
Based on the binary tree, for example, the CCE candidate sorting step S507 can be implemented by adopting a comparison of every two candidates.

Input:
Candidates I and J.

Output:
1 means candidate I has greater impact than candidate J
0 means they have same impact effect.
−1 means the candidate I has less impact than candidate J

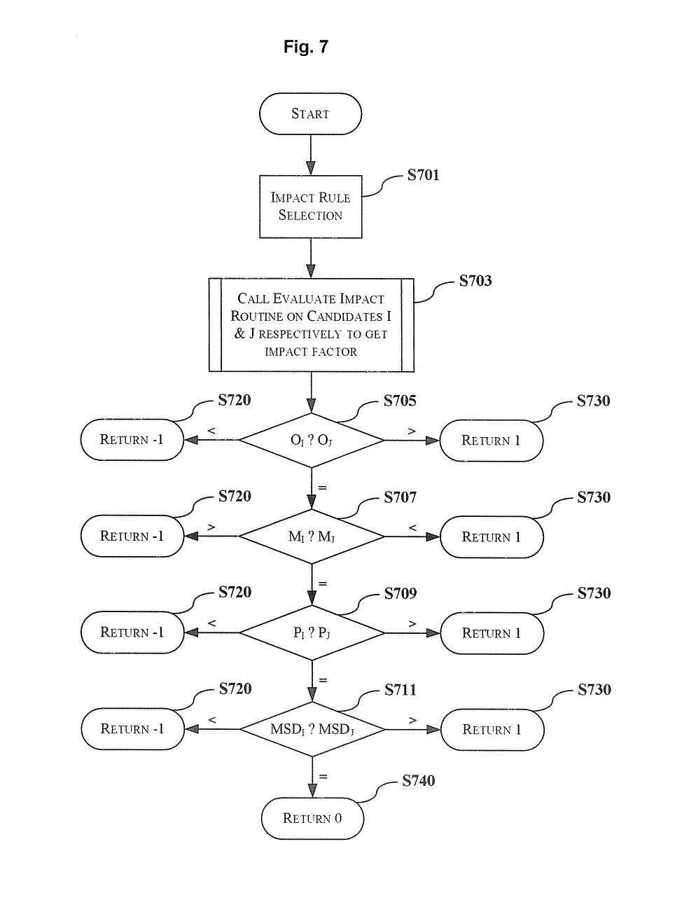

For a given entity, the Compare Candidate routine makes a decision of occupying a CCE candidate and proceeds further exploration. How to select the candidate is based on the comparison of respective impact factor returned by Evaluate Impact Routine (S703 in FIG. 7).

With also the above four impact evaluation rules as example, the Compare Candidate routine will operate as below.
1. MINIMUM AFFECTED ENTITY NUMBER Select the CCE candidate which impacts minimum number of affected entities.
2. MAXIMUM SURVIVING CANDIDATE NUMBER Select the CCE candidate among whose affected entities there exists one with maximum surviving CCE candidate number.
3. LOWEST ENTITY PRIORITY Select the CCE candidate among whose affected entities there exists lowest priority one with at least one surviving candidates after subtracting the direct relative distance.
4. IMPROVED LOWEST ENTITY PRIORITY Select the CCE candidate among whose affected entities within exploration step there exists lowest priority one with at least one surviving candidates after subtracting the effective relative distance.

Four factors are considered on the comparison of impact effect of two candidates on the subsequent entities, which have following preference:
Priority of the 1^{st} impacted entity (reflected by factor O). The so-called 1^{st} impacted entity means the 1^{st} entity which has no surviving candidate after subtracting the effective/direct relative distance, in other word, the 1^{st} impacted the entity may be the first one which fails to get CCE. The priority is just reverse of the index in the sort list. So the littler priority of 1^{st} impacted entity is, the more entities can get CCE allocated.
Surviving factor of the 1^{st} impacted entity (reflected by factor M). The surviving factor is defined as the value of surviving candidate−effective distance. The surviving factor of the 1^{st} impacted entity returned from Evaluate Impact Routine (S703 in FIG. 7) can be ZERO or negative.
Power consumption (reflected by factor P). The power consumption by the CCE candidates. The lower power, the better choice.
The Mean Square Deviation of power (reflected by factor MSD). The power consumption distribution among the PDCCH symbols. The lower MSD means the more even power distribution, of course, the better.

FIG. 7 shows the flowchart of the Compare Candidates Routine.

In step S701, one of impact rules (e.g., improved lowest entity priority) is selected.

In step S703, evaluation impact routine (detailed later) is called for candidates I and J respectively to get impact factors for candidates I and J. The impact factors may include one or more of priority of the 1st impacted entity, surviving factor of the 1st impacted entity, power consumption, and/or the Mean Square Deviation of power.

In steps S705-S711, the above four impact factors are considered in order of preference.

Since the number of entities scheduled simultaneously within one TTI should be NOT many, the priority becomes a critical point which impacts the QoS performance. It is expected the entity with higher priority should try best to be scheduled than that with lower priority. Between two CCE allocation patterns, if one has the 1^{st} impacted entity with higher priority than the other, it should be avoided even if it can fit more entities with lower priority. So the priority of 1^{st} impacted entity is the 1^{st} consideration point (S705). If it can't break the tie (S705:=), it need consider the following factor.

As mentioned in above, the 1^{st} impacted entity is the one whose surviving factor is ZERO or negative. When the surviving factor is greater than ZERO, it can guarantee the entity must be able to get CCE, otherwise it may be NOT exactly correct. Actually the surviving factor just indicates the possibility of successful acquiring the CCE when the value is ZERO or negative. The smaller surviving factor means the lower possibility of acquiring CCE. So if the two CCE refer to the same impacted entity, it then need check the surviving factor the 1^{st} impacted entity (S707). If one CCE candidate achieves the surviving factor as ZERO, the other has −1, then the former is chosen, since the 1^{st} impacted entity is more likely to get CCE in former CCE pattern.

If the above two rules neither can break the tie, the extra points are considered as subsidiary factors. The pattern with minimum and most even power consumption is obviously chosen (S709 and S711).

With the above comparisons S705-711, the procedure will get the output “−1” at step S720, and thus the Candidate I should be preferably selected later, or get the output “1” at step S730, and thus the Candidate J should be preferably selected later; or get the output “0”, and thus either Candidates I and J can be selected with the same preference.

Evaluate Impact Routine

Input
A pointer of CCE candidate (e.g., “I” and “J” in the Compare Candidate Routine)

Output
1. Impact factor M of 1^{st} impacted entity. The impact factor M is defined as following: impact factor=surviving idle candidate number−effective distance to 1^{st} impacted entity.
2. Reverse order number O of 1^{st} impacted entity. If no entity is impacted or all impacted entity's impact factors M are greater than ZERO, return O=0.

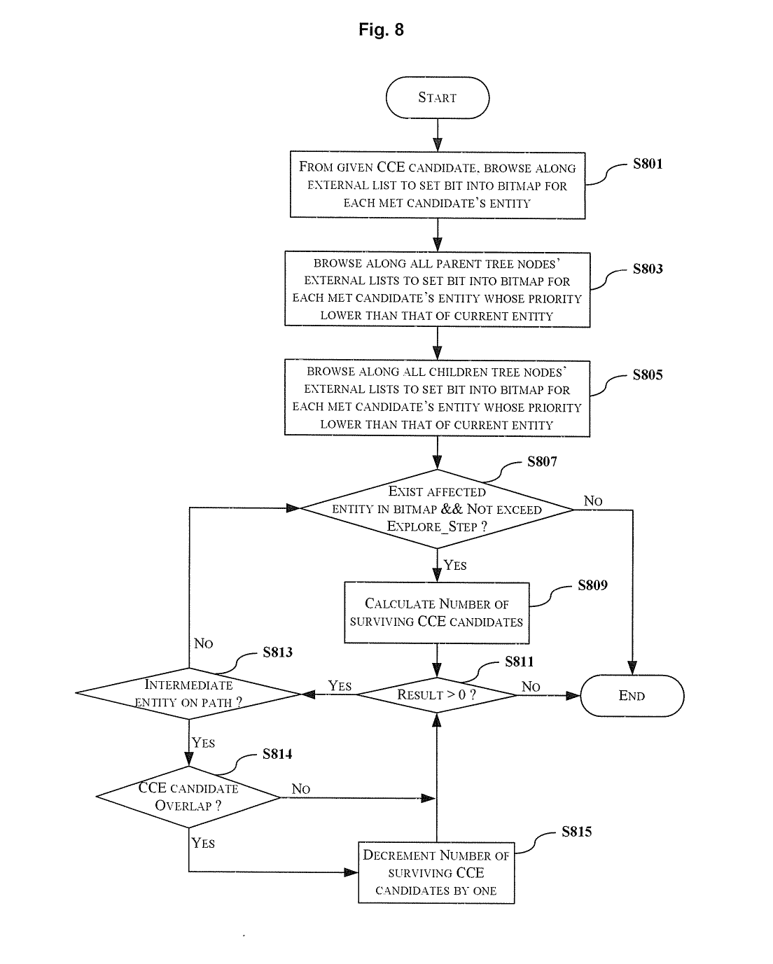

Hereunder, detailed description of the Evaluate Impact Routine will be provided by referring to FIG. 8 which shows the flowchart of the Evaluate Impact Routine (S703 in FIG. 7).
At step S801, from the given CCE candidate, the procedure browses along the external list to set bit into a bitmap for each met candidate's entity.
At step S803, the procedure moves upward from current tree node, for each parent tree node, and repeats above browsing step S801 except of only setting bit for those entities whose priority lower than current entity.
At step S805, the procedure moves down from current tree node, for each sub-tree node, and repeats above browsing step S801 except of only setting bit for those entities whose priority lower than current entity.
At step S807, the procedure checks the bitmap within the exploration step range. If there is NO bit set, it means no entities affected by given CCE candidate, the procedure returns impact factor ZERO immediately, and otherwise the procedure goes to next step.
At step S809, the procedure browses the affected entities within the exploration step to check their surviving CCE candidate number.
At step S811, if there is NO candidate number at all, it means the exploration will have to stop at that entity, the procedure returns ZERO as impact factor as well as the reverse number of that entity; otherwise the procedure goes to step S813.
Until now it means the checked entity still has some idle candidates. However, such idle candidates may be no longer available when the exploration attempt moves to the checked entity, since they may have been blocked by those intermediate entities' candidates. So there is still a need to go further step to adjust it.
At step S813, the procedure browses each intermediate entity along the path between referred entity and the current checked entity. If the intermediate entity has idle candidates overlapped with that of checked entity (S814: Yes), the surviving candidate number is decremented by one at step S815, and then the procedure returns back to step S811; otherwise, the procedure goes to step S811 directly without decrementing the surviving candidate number.
Again at step S811, if the calculated result is smaller than or equals to ZERO, it means the checked entity may not have idle candidates, and the procedure is ended immediately; otherwise the procedure proceeds to next intermediate entity by going to step S813.

The CCE allocation apparatus according to the third embodiment of the present invention includes the similar units as those in the first/second embodiment of the present invention but introduces some minor changes therein. For example, the allocation pattern obtaining unit 3300 is further configured to sort the idle CCE candidates in the idle CCE candidate list, based on a predetermined impact rule, and to preoccupy the idle CCE candidates in order of impact from less to more. (Step S507 in FIG. 5). The other units are identical to those in the first/second embodiment and therefore the detailed descriptions thereof are omitted for simplicity and clarity.

According to the third embodiment of the present invention, the idle CCE candidates are tried according to impact from less to more. Therefore, it is at least with greater possibility that the best CCE allocation pattern can be found as soon as possible.

### Fourth Embodiment

To increase the CCE allocation efficiency further, the cache mechanism may be adopted, which records those historical best patterns at each sub-frame. When the CCE allocation method is started, it searches the cache with input UE list at first. If the UE list is completely matched with an existing record, the best pattern can be returned immediately without running the retrospective allocation method at all. Considering the UE list may exist much longer than frame period (10 ms), the cache hitting probability is relatively high, then it is worthwhile to the cache overhead.

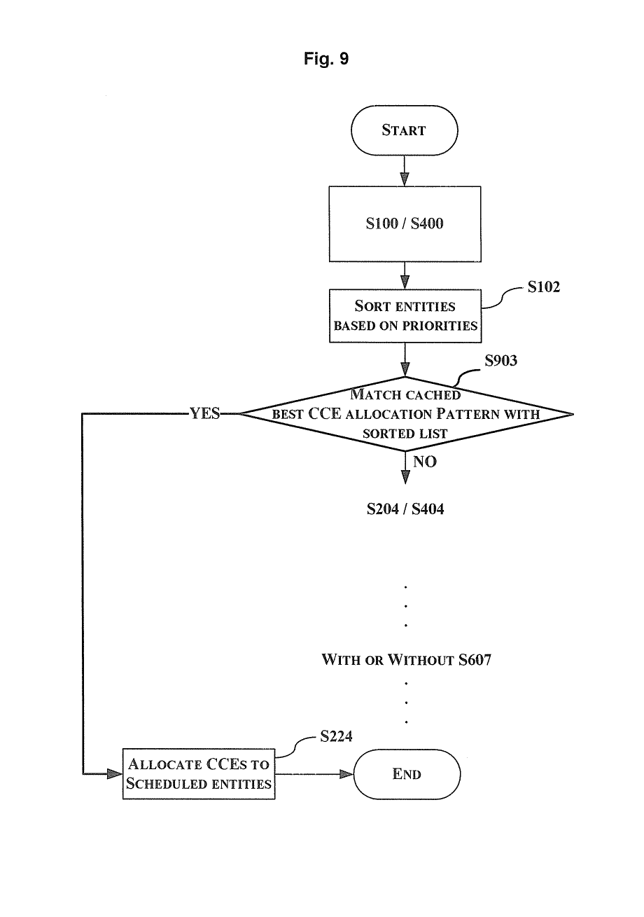

FIG. 9 is a portion of flow chart illustrating the CCE allocation method according to the fourth embodiment of the present invention:

The fourth embodiment can be incorporated into the first or third embodiment by inserting a step S903 between the steps S102 and S204. The other steps are identical or similar to those of the first or third embodiment, and therefore the detailed descriptions thereof are omitted for simplicity. The fourth embodiment can be also incorporated into the second or third embodiment by inserting a step S903 between the steps S102 and S404. The other steps are identical or similar to those of the first or third embodiment, and therefore the detailed descriptions thereof are omitted for simplicity.

In the newly added step S903, cached best CCE allocation patterns are matched with a sorted list of scheduled entities obtained in step S102. If a cached best CCE allocation pattern is matched (S903: YES), CCEs are allocated to the scheduled entities based on the matched cached best CCE allocation pattern (S224), and the CCE allocation method is finished. If a cached best CCE allocation pattern is not matched (S903: NO), the procedure goes to step S204 or step S404 and the CCE allocation method of the first, second or third embodiment is performed.

For the above matching purpose, the best CCE Allocation Pattern can be cached/stored after the best CCE Allocation Pattern is selected (e.g., before or after the allocating step S224 in FIG. 2 or 4), For clarity and simplicity, this caching step is not shown in the drawings.

In the LTE standard, the CCE candidates are calculated by a formula taking RNTI and sub-frame number into considerations, and accordingly a CCE allocation pattern is decided based on a list of RNTI as well as sub-frame number. So long as the entity list (list of RNTI) and sub-frame can match a cached record, the cached result can be reused without running the CCE allocation method again.

However it's may be difficult to cache previous result, because:
The search index is a vector (list of RNTI) instead of a single RNTI. It need completely match all RNTIs in exactly same order of list, which is difficult to generate a vector index,
Because the vector length (number of scheduled entities) and exploration depth (number of entities scheduled per TTI) may be large (vector length may be 1000 and depth may be 32), the total memory consumption will be relatively large if static data structure (such as array) is adopted for quick access (at least 1000×32×10 array elements). If dynamic data structure is adopted (such as linked list), although it does not have to occupy so large memory consumption, the search efficiency may be also degraded accordingly. How to achieve the balance point between the memory consumption and performance becomes a challenging goal.

Here another kind of tree structure (B+ tree) is adopted for each sub-frame, which on one hand uses dynamic memory, will not occupy too large memory; on the other hand, the B+ tree itself is a multiple-fork tree each node has multiple children nodes. Such a parent-children relationship just indicates the order of entities in the list. Once the root of tree can be available, it can go further down along the children branch to get the next entity which is then checked against the next entity in input list. If this child is still matched, then it goes further down; otherwise it checks the child tree node of its next brother along with the sibling list until a matched one is found or no further tree node is matched at all.

Once a fully matched path is found in B+ tree, there is always an external data structure linked with the leaf node, which includes the best CCE allocation pattern corresponding to input entity list, The matched pattern can be directly returned back without running through the CCE allocation procedure again. For the cases where there are a few of UEs and scheduled list order is changed slowly, above cache hit rate is relatively high and the execution efficiency is also high accordingly.

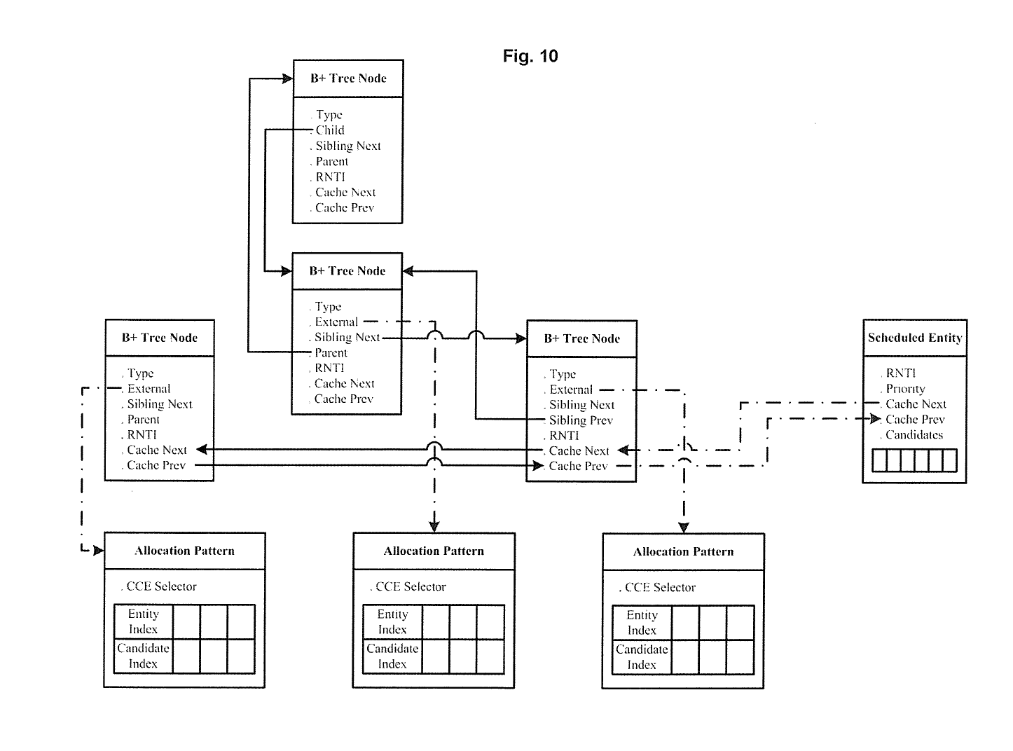

FIG. 10 shows two kinds of data structures, B+ tree and Allocation Pattern, and their relationship together.

1. B+ tree node: acting as cache internal node of B+ tree
Type: type of node (Normal, Leaf, Sibling)
Child/External: pointing to the external Allocation Pattern structure for Leaf node; otherwise pointing to its child B+ tree node
Sibling next: pointing to next node in sibling list
Parent/Sibling prey: pointing to its parent node for the first sibling, otherwise pointing to the previous node in sibling list
RNTI: scheduled entity referred by current B+ tree node, used to check against input parameter
Cache next: pointing to the next B+ tree node belonging to same scheduled entity, facilitating deletion of record from cache once the scheduled entity is removed.
Cache prey: pointing to the previous B+ tree node belonging to same scheduled entity, facilitating deletion of record from cache once the scheduled entity is removed.

2. Allocation pattern: one specific CCE allocation pattern indexed by a list of scheduled entity at specific sub-frame
CCE selector: an array to record a kind of specific CCE allocation pattern, each of which includes two parts information:
   one is the scheduled entity index, the other is corresponding the CCE candidate index within that entity. Through the record, the CCE allocation apparatus can directly return the CCE allocation result without running CCE allocation method again.

Based on the B+ tree, the matching step S903 can be implemented by Search Cache Routine described below.

Search Cache Routine

Input:
The entity list which requests CCE allocation.
Sub-frame No

Output:
If success, return the pointer to Allocation Pattern structure; Otherwise, return pointer to a B+ tree node to which the new inserted node will be appended or NULL as well as the index of 1^{st} unmatched entity in list

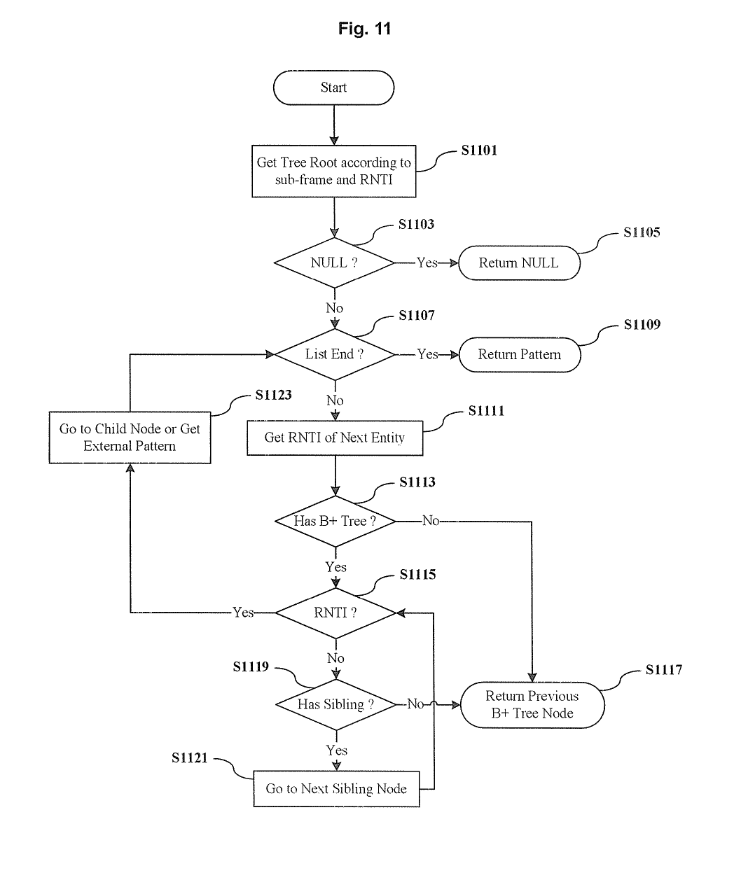

Hereunder, detailed description of the Search Cache Routine will be provided by referring to FIG. 11 which shows the flowchart of the Search Cache Routine.
In step S1101, B+ tree root is got according to the sub-frame. If the B+ tree is NULL, the routine returns immediately (S1103: Yes, S1105) and the retrospective CCE allocation method should be run instead, otherwise (S1103: No) goes to step S1107.
If it hasn't reached the input RNTI list end (S1107: No), the next RNTI is got (S1111).
If current B+ tree node is not NULL (S1113: Yes), it is judged whether current RNTI is compared with the current B+ node key (S1115), otherwise (S1113: No) the routine is ended with return of its parent B+ node for later insertion operation (S1117).
If current RNTI is compared with the current B+ node key (S1115: Yes), then continue to move to its child node (S1123); otherwise (S1115: No), the routine continues to check its brother along the sibling list (S1119, 81121, S1115).
If current RNTI is matched in sibling list (S1115: Yes), then the routine still continues to move to its child node under the brother node (S1123). Until no brother node is found (S1119: No), the routine returns with a previous B+ tree node used for insertion of best CCE pattern returned from the retrospective allocation method later.
The above steps are repeated until the entity list end is reached and then the Allocation Pattern structure from the leaf node is returned (S1109).

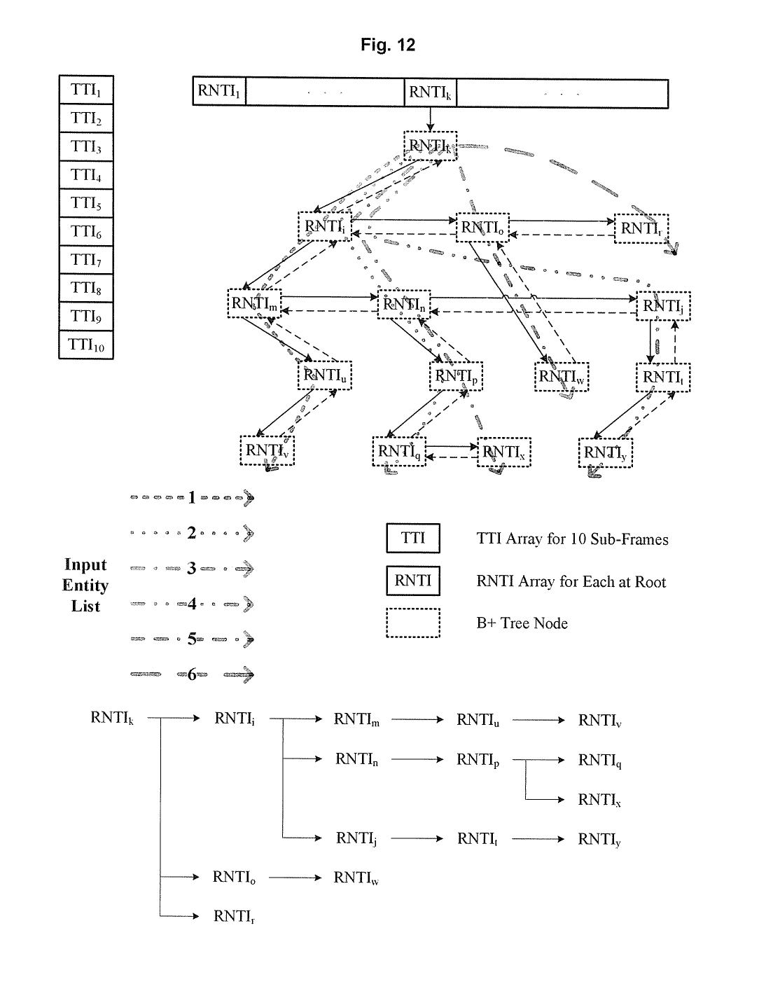

FIG. 12 shows a schematic diagram of search B+ tree scenarios, where it provides 6 different input RNTI lists each marked as different line shapes to distinguish each other. The TTI₁-TTI₁₀ is array of 10 sub-frames, each TTI contains array of RNTIs each of whose elements points to B+ tree, Each time the search the B+ tree is needed, it firstly need fetch the B+ tree root from the array indexed by current sub-frame number. The B+ tree has multiple layers from root to leaf, and each of layer is constructed by the sibling list. The corresponding dashed lines refer to the different search paths from root to leaves and the bottom legend indicates the sequence of RNTIs along the search path for individual input RNTI list.

For the above searching purpose in the Search Cache Routine, after the best CCE Allocation Pattern is selected, this CCE Allocation Pattern can be cached by the following Insert Cache Routine.

Insert Cache Routine

Input:
Allocation Pattern structure from execution of CCE allocation method. A B+ tree node pointer got from pervious invocation of Search Cache
   Routine.
The index of 1^{st} unmatched entity in the list.

Output:
Success or not.

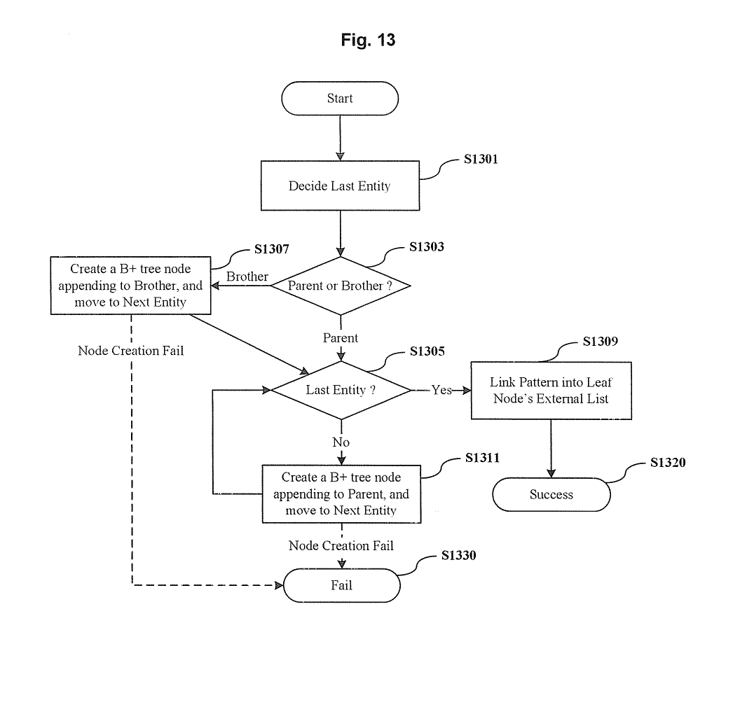

Hereunder, detailed description of the Search Cache Routine will be provided by referring to FIG. 13 which shows the flowchart of the Insert Cache Routine.
In step S1301, the last entity that successfully get its CCE is got, which will be the leaf of the B+ tree.
In step S1303, because previous Search Cache Routine may fail with two different cases: one is failure on sibling list, and the other is failure of getting child node, it is judged which case the current situation is.
For the former case (S1303: Brother), the 1^{st} unmatched entity need be inserted into sibling list at first (S1307) and then the routine goes to the next step S1305; for the latter case (S1303: Parent), the routine directly goes to the next step S1305.
Then, the routine goes through the entity list (S1305), for each subsequent entity, a new B+ tree node is created (S1311) and linked as child node of previous one until the last entity is met which is successfully allocated to the CCE resources (S1309, S1320),
If node creation fails in step S1307 or S1311, the routine fails (S1330).

One thing need be noticed is that when creating B+ tree node, it need not only be linked into the B+ tree, but also be linked to the cache list of corresponding entity which will be used for release of entity later, since an entity may exist in multiple B+ trees, when the entity is released, its all corresponding B+ nodes also need be released. To find all corresponding B+ nodes quickly, they are linked into another list within entity.

When a scheduled entity needs to be released, the corresponding B+ tree nodes can be removed from the cache. This removing procedure can be implemented by the following Delete Cache Routine.

Delete Cache Routine

Input:
A pointer to B+ tree node.
Action Flag with following values:
   0: consider both child and parent nodes
   1: don't care about parent nodes
   2: don't care about children nodes

Output:
N/A

When an entity is deleted, its all B+ tree nodes all need be released. Moreover, the search paths involving those B+ nodes are not valid any more, also need be released. So its all children nodes need be reclaimed and its parent node may be also reclaimed if it has no other brothers. To simplify the code, the procedure adopts iteration implementation.

To avoid dead loop, a parameter: Action is introduced to indicate what kinds of action need be done. When recursively calling Delete Cache Routine for its children nodes to delete sub-tree nodes, it need use Action 1 (don't care about parent), since the invocation is invoked downstream. When recursively calling Delete Cache Routine for its parent nodes to delete parent nodes, it need use Action 2 (don't care about child), since the invocation is invoked upstream.

One thing need be noticed that when releasing the tree node, it need not only unlink from B+ tree, but also from the cache list of corresponding entity. (just opposite to insertion of a B+ node).

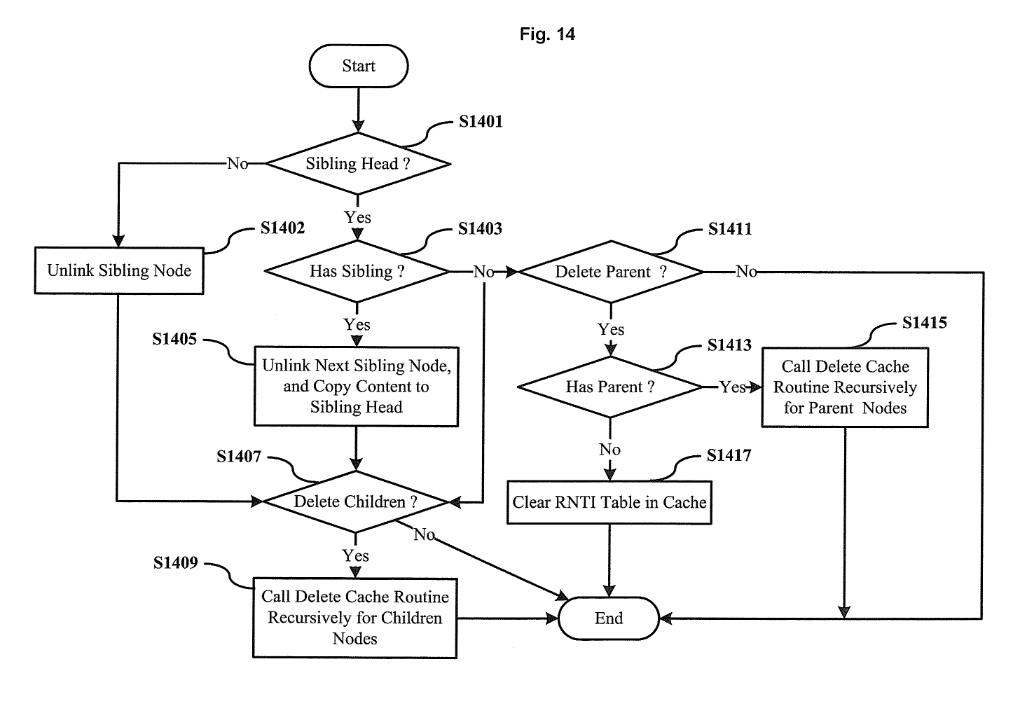

Hereunder, detailed description of the Search Cache Routine will be provided by referring to FIG. 14 which shows the flowchart of the Insert Cache Routine.

In step S1401, it is checked if the current deleted node is sibling list head; if not, it means it still has other brother, then the deleted node is unlinked from sibling list (S1402) and the routine goes to step S1407, otherwise it goes to step S1403.
In step S1403, it is checked if the deleted node has other sibling nodes; if not, it means it has NO other brother, then go to both steps S1407 and S1411; otherwise the deleted node is unlinked from sibling list (S1405) and the routine goes to step S1407;
In step S1407, the input Action flag is checked. If it's 0 or 1, it means it still need delete all its children nodes, then call itself again with Action set to 1 (Don't delete parent, since their patent, just current deleted node, has been deleted) (S1409), otherwise the routine does nothing and returns immediately.
When the routine enters step S1411, it means current deleted node has no more other brothers, so it not only need delete all its children, but also need go upwards to delete its parents if they also have no more brothers. So on one hand, it need call itself with Action flag set to 1 (S1407); on the other hand, it checks if the Action flag is 0 or 2 (S1411). If so, it means it need delete its parent nodes, then the routine goes to step S1413, otherwise the routine does nothing and returns immediately.
In step S1413, it is checked if its patent exists. If so, call itself with Action flag set to 2 (Don't delete child, since its child, current deleted node, has been released) (S1415), otherwise, it has reached the root of B+ tree, the RNTI cache is cleared (S1417) and the routine is ended.

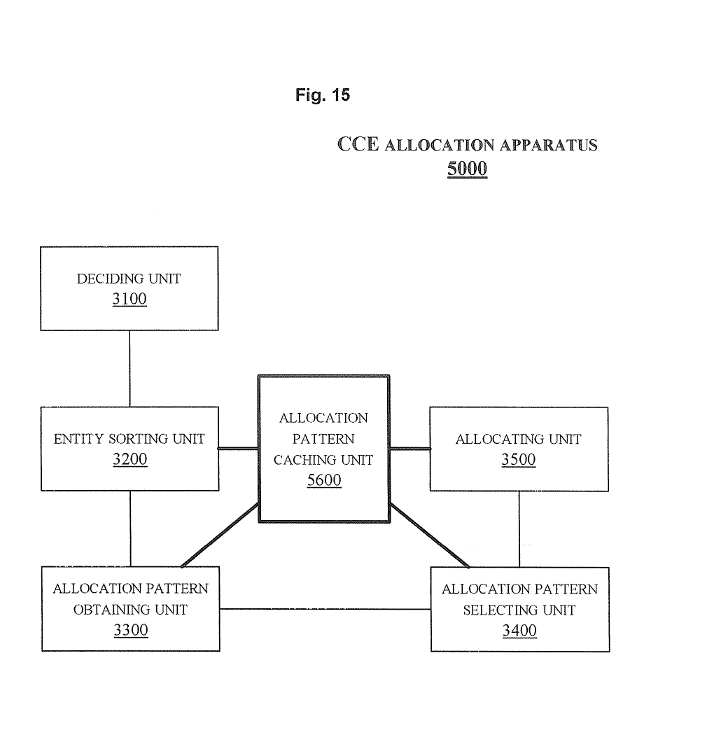

FIG. 15 is a block diagram illustrating the CCE allocation apparatus according to the fourth embodiment of the present invention.

As shown in FIG. 15, the CCE allocation apparatus 5000 according to the fourth embodiment of the present invention differs from the CCE allocation apparatus 3000 shown in FIG. 3 in introducing an allocation pattern caching unit 5600 connected to the entity sorting unit 3200, the allocation pattern obtaining unit 3300, the allocation pattern selecting unit 3400, and the allocating unit 3500.

The allocation pattern caching unit 5600 is configured to cache the CCE allocation pattern selected by the allocation pattern selecting unit 3400 for a predetermined period of time, for example, 10 minutes.

The allocation pattern caching unit 5600 is further configured to match the cached CCE allocation pattern with a sorted list of scheduled entities obtained by the entity sorting unit 3200 (Step S903 in FIG. 9). If the cached CCE allocation pattern is matched, the allocation pattern caching unit 5600 instructs the allocating unit 3500 to directly allocate CCEs to the scheduled entities based on the matched cached CCE allocation pattern without running the CCE allocation procedure according to the first, second or third embodiment. If the cached CCE allocation pattern is not matched, the allocation pattern caching unit 5600 instructs the allocation pattern obtaining unit 3300 to obtain the CCE allocation pattern as in the first, second or third embodiment.

According to the fourth embodiment of the present invention, the obtained CCE allocation pattern will be cached for a term relatively longer than the frame period. With the cached CCE allocation patterns, a lot of repeated allocating procedures will be saved, and therefore, the efficiency of the allocating method can be improved.

[Simulation]

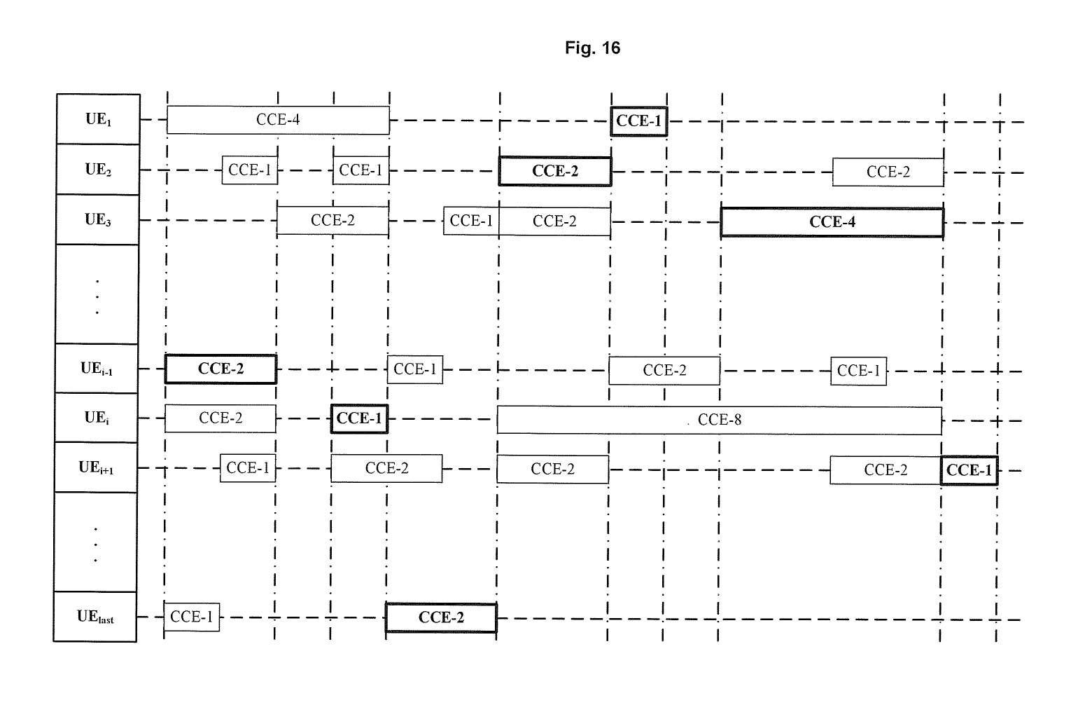

FIG. 16 is a schematic diagram showing a best CCE pattern where a group of UEs are successfully allocated their respective CCE resources. Clearly because such a best pattern is NOT the 1^{st} exploration path in the retrospective allocation method, it won't get the best result if the retrospective mechanism is NOT introduced into CCE allocation.

By the way, it can indicate the advantage of “Improved lowest priority of affected scheduled entity Rule” in prediction mechanism. Let's take the 1^{st} entity as example to demonstrate the prediction working details. From the schematic diagram, 1^{st} entity has two CCE candidates. When deciding which one should be attempted at first, it applies the “Improved lowest priority of affected scheduled entity Rule”.

For the 1^{st} CCE candidate, its 1^{st} impacted entity is UEᵢ (surviving CCE number−effective relative distance is no more than ZERO) whose surviving CCE number is only 1, but the intermediate three UEs all overlap with UE, so the effective distance is 3, then the surviving factor is 1−3=−2.

For the 2^{nd} CCE candidate, its 1^{st} impacted entity is still UEᵢ whose surviving CCE number is 2 (its first two CCE candidates are NOT overlapped by the 2^{nd} CCE of UE₁), the intermediate three UEs also overlap with UEᵢ, thus the effective distance is also 3 (but actually the 3 UEs don't all impact UEᵢ, which also indicates the prediction is NOT exactly accurate, so it's necessary to limit the exploration step), then the surviving factor is 2−3=−1.

According to the “Improved lowest priority of affected scheduled entity Rule”, the CCE with largest surviving factor, the 2^{nd} CCE, is attempted at first. Finally the CCE allocation method finds out all UEs can allocate their CCE resources, the best CCE pattern, so the 1^{st} CCE candidate no longer need be attempted. Compared with the normal retrospective allocation method without prediction (such as the first embodiment), the retrospective allocation method with prediction (such as the third embodiment) can achieve better result with littler time consumption.

The above CCE allocation scheme is simulated with the following parameters:
1. Bandwidth: 20 M
2. CFI=3 symbols
3. 8 UEs in DL and 8 UEs in UL scheduled at each TTI
4. the CCE allocation procedure is performed 10000 times with above configuration to measure the average performance

Table 1 shows the simulation results.

TABLE 1

| No. of | No. of | | | | |
|---|---|---|---|---|---|
| Allocated | Failed | No. of | Minimum | Maximum | Average |
| UEs | UEs | Results | Exe. Time | Exe. Time | Exe. Time |
| 16 | 0 | 9633 | 0.1763 ms | 0.3296 ms | 0.2139 ms |

In most cases, the CCE allocation scheme achieves the 96.33% successful rate of fitting all 16 (8 DL+8 UL) scheduled entities into PDCCH at the cost of execution time 0.2139 ms.

In a word, most of UEs can get their CCE resources through about 0.2 ms execution time.

The foregoing description gives only the preferred embodiments of the present invention and is not intended to limit the present invention in any way. Thus, any modification, substitution, improvement or like made within the spirit and principle of the present invention should be encompassed by the scope of the present invention.

### ABBREVIATIONS

CCE Control Channel Equipment
CFI Control Format Identifier
CQI Channel Quality Indicator
DCI Downlink Control Information
DL Downlink
eNB evolved Node B
LTE Long Term Evolution
PDCCH Physical Downlink Control Channel
PRB Physical Radio Block
RE Resource Element
REG Resource Element Group
RNTI Radio Network Temporary Identifier
TTI Transmission Time Interval
UE User Equipment
UL Uplink

1. A control channel element (CCE) allocation method, comprising steps of:
deciding an aggregation level of each of scheduled entities according to channel quality indicator (CQI) fed back from each of the scheduled entities;
sorting in a list all the scheduled entities based on priority;
obtaining at least two CCE allocation patterns each with preoccupation of CCE candidates by the scheduled entities by use of retrospective mechanism;
selecting a CCE allocation pattern with maximum number of scheduled entities having preoccupied CCE candidates, from the obtained at least two CCE allocation patterns;
allocating CCEs to the scheduled entities based on the selected CCE allocation pattern.

2. The CCE allocation method according to claim 1, wherein the obtaining step comprises:
for each of the scheduled entities in the sorted list,
getting a current scheduled entity from the sorted list and getting idle CCE candidate list of the current scheduled entity, the idle CCE candidate list consisting of one or more idle CCE candidates which are not preoccupied by previous scheduled entities in the sorted list and are available to the current scheduled entity;
in case where an idle CCE candidate for the current scheduled entity exists in the idle CCE candidate list of this current scheduled entity, preoccupying the idle CCE candidate, and moving to next scheduled entity in the sorted list; and
in case where no idle CCE candidate for the current scheduled entity exists in the idle CCE candidate list of this current scheduled entity, storing a CCE allocation pattern with preoccupation of CCE candidates by respective scheduled entities, returning back to previous scheduled entity and proceeding from next idle CCE candidate in the idle CCE candidate list of the previous scheduled entity,
until all of the scheduled entities have preoccupied CCE candidates or it reaches an execution time limit, ending the obtaining step.

3. The CCE allocation method according to claim 2, wherein the idle CCE candidate list of the current scheduled entity includes both CCE candidates of the aggregation level decided according to the CQI fed back by the current scheduled entity and CCE candidates of aggregation levels higher than that decided according to the CQI fed back by the current scheduled entity.

4. The CCE allocation method according to claim 3, wherein
the deciding step further comprises: deciding an aggregation level of each of the scheduled entities according to CQI fed back from the scheduled entity and aggregation levels higher than the aggregation level of the scheduled entity, and deciding related powers of the respective aggregation levels, and
the selecting step further comprises: selecting a CCE allocation pattern with maximum number of scheduled entities having preoccupied CCE candidates and with minimum of total power consumption of the preoccupied CCE candidates, from the obtained at least two CCE allocation patterns.

5. The CCE allocation method according to claim 3, wherein
the deciding step further comprises: deciding an aggregation level of each of the scheduled entities according to CQI fed back from the scheduled entity and aggregation levels higher than the aggregation level of the scheduled entity, and deciding related powers of the respective aggregation levels, and
the selecting step further comprises: selecting a CCE allocation pattern having the maximum number of scheduled entities having preoccupied CCE candidates and having the most even power distribution of the preoccupied CCE candidates, from the obtained at least two CCE allocation patterns.

6. The CCE allocation method according to claim 2, wherein
in the idle CCE candidate list, the idle CCE candidates are sorted based on a predetermined impact rule, and the idle CCE candidates are preoccupied in order of impact from less to more.

7. The CCE allocation method according to claim 6, wherein
the predetermined impact rule is an improved lowest priority of affected scheduled entity rule in which the idle CCE candidate with the lowest priority of impacted entity which has at least one surviving candidates after subtracting an effective distance to the current scheduled entity is recognized as one with lest impact, the effective distance between a subsequent scheduled entity to the current scheduled entity is defined as number of intermediate scheduled entities which have idle their CCE candidates overlapping with the subsequent entity within exploration step.

8. The CCE allocation method according to claim 1, further comprising:
caching the selected CCE allocation pattern for a predetermined period of time.

9. The CCE allocation method according to claim 8, further comprising, after the sorting step,
matching the cached CCE allocation pattern with a sorted list of scheduled entities;
in case where the cached CCE allocation pattern is matched, allocating CCEs to the scheduled entities based on the matched cached CCE allocation pattern, and ending the CCE allocation method; and
in case where no cached CCE allocation pattern is matched, going to the subsequent steps.

10. A control channel element (CCE) allocation apparatus, comprising:
a deciding unit configured to decide an aggregation level of each of scheduled entities according to channel quality indicator (CQI) fed back from each of the scheduled entities;
an entity sorting unit configured to sort in a list all the scheduled entities based on priority;
an allocation pattern obtaining unit configured to obtain at least two CCE allocation patterns each with preoccupation of CCE candidates by the scheduled entities, by use of retrospective mechanism;
an allocation pattern selecting unit configured to select a CCE allocation pattern with maximum number of scheduled entities having preoccupied CCE candidates, from the obtained at least two CCE allocation patterns;
an allocating unit configured to allocate CCEs to the scheduled entities based on the selected CCE allocation pattern.

11. The CCE allocation apparatus according to claim 10, wherein the allocation pattern obtaining unit is further configured to:
for each of the scheduled entities in the sorted list,
get a current scheduled entity from the sorted list and getting idle CCE candidate list of the current scheduled entity, the idle CCE candidate list consisting of one or more idle CCE candidates which are not preoccupied by previous scheduled entities in the sorted list and are available to the current scheduled entity;
in case where an idle CCE candidate for the current scheduled entity exists in the idle CCE candidate list of this current scheduled entity, preoccupy the idle CCE candidate, and move to next scheduled entity in the sorted list; and
in case where no idle CCE candidate for the current scheduled entity exists in the idle CCE candidate list of this current scheduled entity, store a CCE allocation pattern with preoccupation of CCE candidates by respective scheduled entities, return back to previous scheduled entity and proceed from next idle CCE candidate in the idle CCE candidate list of the previous scheduled entity,
until all of the scheduled entities have preoccupied CCE candidates or it reaches an execution time limit, end the operation of the allocation pattern obtaining unit.

12. The CCE allocation apparatus according to claim 11, wherein the idle CCE candidate list of the current scheduled entity includes both CCE candidates of the aggregation level decided according to the CQI fed back by the current scheduled entity and CCE candidates of aggregation levels higher than that decided according to the CQI fed back by the current scheduled entity.

13. The CCE allocation apparatus according to claim 11, wherein
the allocation pattern obtaining unit is further configured to sort the idle CCE candidates in the idle CCE candidate list, based on a predetermined impact rule, and to preoccupy the idle CCE candidates in order of impact from less to more.

14. The CCE allocation apparatus according to claim 10, further comprising:
an allocation pattern caching unit configured to cache the selected CCE allocation pattern for a predetermined period of time.

15. The CCE allocation apparatus according to claim 14, wherein the allocation pattern caching unit is further configured to match the cached CCE allocation pattern with a sorted list of scheduled entities, and
the allocating unit is further configured to, in case where the cached CCE allocation pattern is matched, allocate CCEs to the scheduled entities based on the matched cached CCE allocation pattern.
